(19) United States
(12) Patent Application Publication
(10) Pub. No.: US 2004/0034154 A1
(43) Pub. Date: Feb. 19, 2004

(54) Epoxide-type formaldehyde free insulation binder

(75) Inventors: Kim Tutin, Stone Mountain, GA (US); Pablo Dopico, Conyers, GA (US); Shahid Qureshi, Duluth, GA (US); John Hines, Atlanta, GA (US); Kurt Gabrielson, Liburn, GA (US); Randy White, Conyers, GA (US)

Correspondence Address: BANNER & WITCOFF, 1001 G STREET N W, SUITE 1100, WASHINGTON, DC, 20001, US

(73) Assignee: Georgia-Pacific Resins Corporation, Atlanta, GA

(21) Appl. No.: 10/453,891

(22) Filed: Jun. 4, 2003

Related U.S. Application Data
(60) Provisional application No. 60/385,903, filed on Jun. 6, 2002.
(60) Provisional application No. 60/388,744, filed on Jun. 17, 2002.

(51) Int. Cl. C08L 51/00

(52) U.S. Cl. 524/538; 524/539; 524/601

(57) ABSTRACT

An aqueous binder composition containing a substantially infinitely water-dilutable or dispersible mixture of an epoxide and an epoxide crosslinking agent and the related method of its use for making glass fiber products, such as fiberglass insulation.

This application claims the benefit under 35 U.S.C. § 119(e)(1) of prior filed provisional applications 60/385,903 and 60/388,744, filed Jun. 6, 2002 and Jun. 17, 2002, respectively.

### FIELD OF THE INVENTION

The present invention relates to a new formaldehyde-free binder composition to the related method of its use for making fiberglass insulation and related fiberglass products (glass fiber products) and to the glass fiber products themselves. The present invention particularly relates to an aqueous binder composition containing a substantially infinitely water-dilutable or water dispersible mixture of an epoxide and a multi-functional crosslinker reactive with the epoxide such as a polyamidoamine polymer.

### BACKGROUND OF THE INVENTION

Phenol-formaldehyde (PF) resins, as well as PF resins extended with urea (PFU resins), have been the mainstays of fiberglass insulation binder technology over the past several years. Such resins are inexpensive and provide the cured fiberglass insulation product with excellent physical properties.

One of the drawbacks of this technology, however, is the potential for formaldehyde emissions during the manufacturing of the fiberglass insulation.

Fiberglass insulation is typically made by spaying a dilute aqueous solution of the PF or PFU resin binder onto a moving mat or blanket of non-woven glass fibers, often hot from being recently formed, and then heating the mat or blanket to an elevated temperature in an oven to cure the resin. Manufacturing facilities using PF and PFU resins as the main binder component for insulation products recently have had to invest in pollution abatement equipment to minimize the possible exposure of workers to formaldehyde emissions and to meet Maximum Acheiveable Control Technology (MACT) standards.

As an alternative to PF and PFU resins, certain formaldehyde free formulations have been developed for use as a binder for making fiberglass insulation products. One of the challenges to developing suitable alternatives, however, is to identify formulations that have physical properties (viscosity, dilutability, etc.) and characteristics similar to the standard PF and PFU resins, i.e., formulations which also have a similar cure time/cure temperature profile, while yielding a cured fiberglass insulation product with equivalent physical properties.

U.S. Pat. No. 5,318,990 describes a formaldehyde free formulation for fiberglass insulation based on an aqueous solution of a polymeric carboxylic acid, such as a polyacrylic acid, and a triol, such as glycerol, trimethylolpropane and the like. Other polyols may optionally be present. The formulation relies on the presence of a phosphorus accelerator (catalyst) in the aqueous solution to obtain an effective cure at suitable temperatures.

U.S. Pat. No. 5,340,868 describes a binder for making a fiberglass mat comprising an aqueous solution of a polymeric carboxylic acid, such as polyacrylic acid, a β-hydroxyalkylamide and an at least tri-functional monomeric carboxylic acid, such as citric acid, trimetallitic acid, hemimellitic acid, trimesic acid, tricarballylic acid, 1,2,3,4-butanetetracarboxylic acid (BTCA) and pyromellitic acid.

U.S. Pat. No. 5,393,849 describes a curable composition useful in making binder formulations made by combining an unsaturated polyester resin and a polyamino compound.

U.S. Pat. No. 5,661,213 describes a formaldehyde free formulation for fiberglass insulation based on an aqueous solution of a polyacid, such as a polyacrylic acid, and a polyol (at least a diol), with a molecular weight less than about 1000 such as, for example, ethylene glycol, glycerol, pentaerythritol, trimethylol propane, sorbitol, sucrose, glucose, resorcinol, catechol, pyrogallol, glycollated ureas, 1,4-cyclohexane diol, diethanolamine, triethanolamine, and certain reactive polyols such as, for example, β-hydroxyalkylamides. The formulation relies on the presence of a phosphorus accelerator (catalyst) in the aqueous solution to obtain an effective cure at suitable temperatures.

U.S. Pat. No. 5,932,689 describes a formaldehyde free formulation for fiberglass insulation based on a combination of three components (1) a polyacid, such as polyacrylic acid, (2) an active hydrogen-containing compound, such as a polyol, or a polyamine, and (3) a cyanamide, a dicyanamide or a cyanoguanidine. In this formulation, an accelerator (catalyst) is said to be optional. Suitable accelerators include a phosphorus or fluoroborate compound.

U.S. Pat. No. 5,977,232 describes a formaldehyde free formulation for fiberglass insulation based on a combination of three components (1) a polyacid, such as polyacrylic acid, (2) an active hydrogen-containing compound, such as a polyol, or a polyamine, and (3) a fluoroborate accelerator.

U.S. Pat. No. 6,039,821 describes a process for producing a bonded, non-woven fibrous batt using a solid binder of a solid epoxy resin and a cross-linking agent. While glass fibers are listed as a suitable fiber (col. 11, line 20), there is no mention of making a fiberglass insulation using the binder.

U.S. Pat. No. 6,114,464 describes a binder for producing shaped articles, such as chipboard, comprising a curable composition of an addition polymer of an unsaturated mono- or dicarboxylic acid and a multi-hydroxyalkylated polyamine.

U.S. Pat. No. 6,171,654 describes preparing fiberglass insulation using a water soluble or water-dispersible curable polyester resin binder formed by reacting a polyol, such as pentaerythritol, a terephthalate polymer, such as recycled polyethylene terephthalate (PET), a polyacid, such as isophthalic and terephthalic acid, an end (mono-functional) acid, a reactive diluent (crosslinker) such as a melamine resin, and an acid catalyst.

U.S. Pat. No. 6,331,350 describes a binder formulation for fiberglass very similar to U.S. Pat. No. 5,661,213 except that the pH of the aqueous solution is adjusted to less than 3.5.

Despite these disclosures, there is a continuing need for identifying new formaldehyde-free, curable aqueous compositions suitable for use as a binder for fiberglass, especially for making glass fiber products such as fiberglass insulation.

### DETAILED DESCRIPTION OF THE INVENTION

The present invention is directed to an epoxide binder composition, the related method of its use for making glass fiber insulation products and related products, such as thin fiberglass mats (all hereinafter referred to generically as glass fiber products) and the glass fiber products, especially fiberglass insulation products, made with the cured (crosslinked) binder. The present invention particularly relates to an aqueous binder composition containing a substantially infinitely water-dilutable or dispersible mixture of an epoxide and an epoxide crosslinking agent.

The binder is applied as a dilute aqueous solution to a mat or blanket of glass fibers and cured by heat.

As used herein, “curing,” “cured” and similar terms are intended to embrace the structural and/or morphological change which occurs in the aqueous epoxide binder of the present invention as it is dried and then heated to cause the properties of a flexible, porous substrate, such as a blanket of glass fiber to which an effective amount of the binder has been applied, to be altered such as, for example, by covalent chemical reaction, ionic interaction or clustering, improved adhesion to the substrate, phase transformation or inversion, and hydrogen bonding.

By “formaldehyde-free” is meant that the composition is substantially free from formaldehyde, and does not liberate substantial formaldehyde as a result of drying and/or curing; typically, less than 1 ppm formaldehyde, based on the weight of the composition, is present in a formaldehyde-free composition. In order to minimize the formaldehyde content of the composition it is preferred to use additives that are themselves free from formaldehyde and do not generate formaldehyde during drying and/or curing.

As used herein, “aqueous” includes water and mixtures composed substantially of water and water-miscible solvents.

As used herein the phrases “glass fiber,” fiberglass” and the like are intended to embrace heat-resistant fibers suitable for withstanding elevated temperatures such as mineral fibers, aramid fibers, ceramic fibers, metal fibers, carbon fibers, polyimide fibers, certain polyester fibers, rayon fibers, and especially glass fibers. Such fibers are substantially unaffected by exposure to temperatures above about 120° C.

As used throughout the specification and claims, the terms mat and blanket are used somewhat interchangeably to embrace a variety of glass fiber substrates of a range of thickness and density, made by entangling short staple fibers, long continuous fibers and mixtures thereof.

In a first aspect, the present invention is directed to an aqueous binder composition containing a substantially infinitely water-dilutable or dispersible mixture of an epoxide and an epoxide crosslinking agent.

In another aspect, the present invention provides a method for binding together a loosely associated mat of glass fibers comprising (1) contacting said glass fibers with a curable epoxide binder composition as defined above, and (2) heating said curable binder composition at an elevated temperature, which temperature is sufficient to effect cure. Preferably, curing is effected at a temperature from 110° C. to 300° C. more preferably less than 250° C.

In yet another aspect, the present invention provides a glass fiber product, especially a glass fiber insulation product, comprising a crosslinked (cured) binder composition obtained by curing an epoxide binder composition as defined above applied as an aqueous composition to a mat or blanket of nonwoven glass fibers.

The aqueous epoxide binder composition of the present invention is prepared simply by mixing an epoxide with an epoxide crosslinking agent, such as a polyamidoamine polymer, to form an aqueous epoxide binder composition. Suitable polyamidoamine polymer are prepared by reacting a polyamine with a diacid.

The key component of the binder composition of the present invention is the epoxide. The epoxide is an infinitely water dilutable or dispersible, non-resinous compound having a molecular weight below about 750 and usually below about 500. The epoxide has at least two epoxy groups. Suitable epoxides for practicing the present invention are generally infinitely water dilutable or dispersible diglycidyl ethers of a polyol. Suitable polyols for making the epoxide include bisphenol A, bisphenol F, glycerol and tetrakis (hydroxyphenyl) ethane. Methods for making such diglycidyl ethers are well understood by those skilled in the art and involve reacting glycidol with the polyol under appropriate conditions. The diglycidyl ether of bisphenol A is preferred.

As will be explained in more detail hereafter, the epoxide then is formulated into an aqueous solution with an infinitely water dilutable or dispersible epoxide crosslinking agent and used as a binder for glass fibers. Suitable water dilutable epoxide crosslinking agents useful with the above-identified epoxides are well-known. Such crosslinking agents have two or more reactive groups that react with the epoxy groups of the epoxide. Examples of suitable cross-linking agents include: polycarboxylic acids, polycarboxylic acid anhydrides, acid terminated polyesters, polyfunctional amines, polyamidoamines, dicyandiamide derivatives and imidazoles.

Examples of suitable polycarboxylic acids include among others: phthalic acid, maleated rosin, isophthalic acid, terephthalic acid, trimellitic acid, maleic acid, adipic acid, decanedioic acid, polymaleic acid, maleated fatty acids and dodecanedioic acid. Other suitable polycarboxylic acids are aconitic acid, azelaic acid, butane tetra carboxylic acid dihydride, butane tricarboxylic acid, chlorendic anhydride, citraconic acid, citric acid, dicyclopentadiene-maleic acid adducts, diethylenetriamine pentacetic acid pentasodium salt, adducts of dipentene and maleic anhydride, endomethylenehexachlorophthalic anhydride, ethylenediamine tetraacetic acid (EDTA), fumaric acid, glutaric acid, itaconic acid, malic acid, mesaconic acid, novolak (such as biphenol A or bisphenol F) reacted via KOLBE-Schmidt reaction with carbon dioxide to introduce 3-4 carboxyl groups, oxalic acid, polylactic acid, ammonia reacted with 3 moles chloroacetic acid, triethanolamine reacted with 3 moles of maleic anhydride, sebacic acid, succinic acid, tartaric acid, tetrabromophthalic anhydride, tetrachlorophthalic anhydride, tetrahydrophthalic anhydride and trimesic acid. The corresponding anhydrides also are included.

Examples of suitable polycarboxylic acid anhydrides include among others: phthalic anhydride, maleic anhydride, trimellitic anhydride, pyromellitic dianhydride (sometimes called “PMDA”) and benzophenone tetradicarboxylic acid dianhydride (sometimes called “BDTA”).

Acid terminated polyesters useful as cross-linking agents in the present invention are generally the water dilutable reaction product of a polyol and a polycarboxylic acid. Useful polyols for making such polyesters include among others: ethylene glycol, diethylene glycol, neopentyl glycol, propylene glycol, 1,4-butane diol, trimethylol propane and glycerol. Other suitable polyols include 1,4-cyclohexanediol, catechol, cyanuic acid, diethanolamine, pryogallol, 1,6-hexane diol, 1,2,6 hexanetriol, 1,3 butanediol, 1,4-cyclohexane dimethanol, 2,2,4 trimethylpentanediol, alkoxylated bisphenol A, Bis[N,N di beta-hydroxyethyl)]adipamide, bisphenol A, bisphenol A diglycidyl ether, bisphenol F diglycidyl ether, cyclohexanedimethanol, dibromoneopentyl glycol, dipropylene glycol, ethoxylated DETA, novolac reacted with ethylene carbonate, novolac reacted with ethylene oxide, pentaerythritol, polyalkylene glycols, polyethylene glycol, polypropylene glycol, propane 1,3 diol, sorbitol, tartaric acid, tetrabromoalkoxylate bisphenol A, tetrabromobisphenol A, tetrabromobisphenol diethoxy ether, triethanolamine, triethylene glycol, trimethylolethane, trimethylolpropane and tripropylene glycol. Suitable polycarboxylic acids include all those listed above.

The preferred crosslinking agents are polyfunctional amines having secondary and tertiary amine groups, which are known to react with epoxy groups at the desired reaction rate. Included within the class of polyfunctional amines are polyamidoamines, amino acids and polypeptides (such as soy protein), polyethyleleneimines (PEI), polyallylamines, polydiallylamines, polyanilines and polyvinylamines. Another suitable amine is dicyandiamide. Although it can be used alone, it is commonly used with one or more imidazoles and/or one or more imidazolines. Examples of suitable imidazoles include among others: 2-methyl-imidazole, 2-phenyl-imidazole, and 2-ethyl-4-methyl-imidazole. Examples of suitable imidazolines include among others: 2-phenyl-imidazoline.

Preferred as the epoxide crosslinking agent are certain polyamidoamine polymers having a plurality of amine groups (generally primary, secondary and tertiary amines) and having an average molecular weight in the range of 200-40,000, usually in the range of 300-10,000 and most often in the range of 300 to 5,000. The preferred polyamidoamine polymer is a reaction product of a polyamine and a diacid conducted under conditions to retain primary amine groups at the terminus of the polymer.

The step of forming a polyamidoamine polymer involves reacting a dicarboxylic acid (diacid), (or a corresponding dicarboxylic acid halide, or diester thereof) with a polyalkylene polyamine. Such polymers are well known to the art and find widespread use in the manufacture of wet strengthening agents for paper products.

The polyamidoamine polymer used in preparing the binder of the present invention can be prepared according to this known technology by reacting a polyamine, such as diethylenetriamine, with a diacid, such as adipic acid. The polyamine and diacid usually are reacted at a mol ratio of 0.1 to 10 moles of primary amine moiety per mole of carboxylic acid moiety, more usually at a mol ratio of 0.7 to 1.9 moles of primary amine moiety per mole of carboxylic acid moiety and most often at a mol ratio of 1.0 to 1.5 moles of primary amine moiety per mole of carboxylic acid moiety. Usually, a suitable mole ratio of diethylenetriamine (two primary amine moieties) to adipic acid (two carboxylic acid moieties) will be in the range of about 0.7:1 to about 1.9:1 and preferably is about 1.3:1.

Suitable polyamines, also referred to as polyalkylene polyamines, which may be used in the invention for making the polyamidoamine polymer, have two primary amine groups (—NH₂) and optionally secondary or tertiary amine moieties. Such polyamines include diamines of the formula NH₂(CH₂)ₙNH₂ (where n=2 to 12), polyamines of the formula NH₂((CH₂)ₙNH)ₓ—(CH₂)ₙNH₂ (where n=1 to 4 and x=1 to 4), branched or cyclic diamines or polyamines and mixtures of these materials. Commercially available polyalkylene polyamines, which are mixtures of linear, branched and cyclic polyalkylene polyamines, also are suitable for use in producing the polyamidoamine polymer. The term polyalkylene polyamine as employed herein is intended to include polyalkylene polyamines in pure or relatively pure form, mixtures of such materials, and crude polyalkylene polyamines, which are commercial products and may contain minor amounts of other compounds.

Illustrative of suitable polyalkylene polyamines are polyethylenepolyamines such as diethylenetriamine, triethylenetetramine, dipropylenetriamine, aminoethyl piperazine, tetraethylenepentamine, pentaethylenehexamine, N-(2-aminoethyl)piperazine, N,N-bis(2-aminoethyl)-ethylenediamine, diaminoethyl triaminoethylamine, piperazinethyl, and the like. The corresponding polypropylenepolyamines and the polybutylenepolyamines can also be employed. Still other polyamines will be recognized by those skilled in the art and the present invention can be used with such polyamines. Polyethylenepolyamines are preferred for economic reasons. Due to its availability and wide use, diethylenetriamine is particularly preferred for use in the practice of the invention.

Diacids, which can be used in the preparation of the polyamidoamine polymer, include saturated aliphatic diacids such as malonic, oxalic, succinic, glutaric, 2-methylsuccinic, adipic, pimelic, suberic, sebacic, azelaic, undecanedioic, dodecandioic, 2-methylglutaric, and 3,3-dimethylglutaric; alicyclic saturated acids such as 1,2-cyclohexanedicarboxylic, 1,3-cyclohexanedicarboxylic, 1,4cyclohexanedicarboxylic and 1-3-cyclopentanedicarboxylic; unsaturated aliphatic acids such as maleic, fumaric, itaconic, citraconic, mesaconic, aconitic and hexane-3-diotic; unsaturated alicyclic acids such as Δ⁴-cyclohexenedicarboxylic; aromatic acids such as phthalic, isophatlic, terephthalic, 2,3-naphthalenedicarboxylic, benzene-1,4-diacetic, and heteroaliphatic acids such as diglycolic, thiodiglycolic, dithiodiglycolic, iminodiacetic and methyliminodiacetic. Still other diacids will be recognized as suitable by those skilled in the art and the present invention is not limited to any particular diacids. As well-recognized by those skilled in the art, it is to be understood that the corresponding esters, anhydrides and halides of such acids, which function as a diacid under known reaction conditions with the polyamine, also can be used and are considered to be a diacid as this term is defined and used in this disclosure. Suitable esters are the lower alkyl diesters produced by reacting a diacid with a monohydric alcohol and include dimethylmalonate, dimethyladipate, dimethylglutarate and dimethylsebacate. Diacids and diesters of the formula RO₂C—(CH₂)ₙ—CO₂R (where n=1 to 10 and R═H, methyl or ethyl), mixtures thereof and corresponding halides thereof are preferred. Adipic acid is readily available and has been widely used. Thus, adipic acid is particularly preferred as the diacid. For similar reasons, dimethyladipate and dimethylglutarate are preferred diesters.

The reaction of the polyalkylene polyamine, such as diethylenetriamine with, for example, the diacid, such as adipic acid, to produce the polyamidoamine polymer component of the binder composition of this invention is well understood. As understood by those skilled in the art, the reaction may be carried out under anhydrous conditions, or in the presence of water. The reaction is generally conducted at atmospheric pressure with reflux and usually at a temperature in the range of about 40° to 250° C. Thus, the reaction may occur at temperatures as low as 60° C., but temperatures above about 100° C. are generally employed and temperatures up to about 250° C., or higher may be used. The reaction is more usually conducted at a temperature within the range of 110° to 200° C., with a temperature in the range of 140° to 190° C. often preferred. It also is possible to use either below atmospheric, or above atmospheric conditions, though based on considerations of cost and convenience, normal atmospheric pressure operation is preferred. A temperature in the range of 150° to 180° C. is generally most preferred. Heat must be added to condense the two reactants and liberate water.

Often, sufficient diacid (or the corresponding diester or acid halide thereof) is supplied to react substantially completely with the primary amine groups on the polyalkylene polyamine, but the amount of diacid is insufficient to react with secondary amine groups to any substantial extent. Thus, when using a polyalkylene polyamine having two primary amine groups an appropriate mol ratio of polyalkylene polyamine to diacid (or diester or acid halide) will be between about 0.1:1 to 10:1 (polyamine:diacid), more usually between about 0.7:1 to about 1.9:1, preferably will lie between about 0.9:1 to about 1.5:1 and most preferably will be between 1:1 to about 1.4:1.

As is fairly conventional, this reaction is usually conducted by step-growth polymerization. The diacid is added to the amine accompanied by an exotherm, usually to a temperature of about 145° C. The reaction mixture then is heated, usually to a temperature of about 165° C. and the reaction is continued until a desired molecular weight is reached, which often is monitored by following the viscosity increase of the reaction mixture. Water typically is distilled from the reaction mixture to drive the reaction to a higher degree of condensation. The reaction conditions (including inter alia, mol ratio, reaction temperature and reaction time) are normally adjusted to produce a polyamidoamine polymer with a weight average molecular weight in the range of about 200 to 40,000 and higher, preferably in the range of about 300 to about 10,000 and more preferably in the range of about 300 to about 5,000. The desired molecular weight and viscosity are generally obtained by adding fresh water to a neat, molten polyamidoamine polymer to halt the condensation reaction at the desired degree of polymerization, as is understood by those skilled in the art. Weight average molecular weight, as used throughout the specification and claims, can be determined by comparing the respective polymer with a known standard using gel permeation chromatography (GPC).

The binder is formulated simply by mixing the epoxide and the epoxide crosslinking agent, such as the preferred polyamidoamine, at a suitable mole ratio in a aqueous solvent. Usually, the mole ratio of the repeat unit of the epoxide crosslinking agent, such as a polyamidoamine polymer repeat unit, to the epoxide repeat unit in the fully formulated binder is in the range of 0.1:1.0 to 10.0:1.0, more usually, this mole ratio is in the range of 0.5:1.0 to 1.5:1.0 and preferably this mole ratio is about 1:1, i.e., 0.9:1 to 1.1:1. Those skilled in the art readily appreciate the concept of repeat unit for the suitable crosslinking agents, such as a polyamidoamine polymer and for the epoxide. For example, for a polyamidoamine polymer made by reacting diethylenetriamine and adipic acid the repeat unit refers to the combination of one adipic acic molecule and one diethylenetriamine molecule.

In operation, the epoxide binder of the present invention is formulated into a dilute aqueous solution or aqueous dispersion and then applied to glass fibers as they are being produced and formed into a mat or blanket, water is volatilized from the binder, and the high-solids binder-coated fibrous glass mat or blanket is heated to cure the binder and thereby produce a finished glass fiber product, such as fiberglass insulation.

The epoxide binder solution for making glass fiber products in accordance with the present invention is generally provided as a water soluble or water dispersable composition which can be easily blended with other ingredients and diluted to a low concentration which is readily sprayed onto the fibers as they fall onto the collecting conveyor. The binder composition is generally applied in an amount such that the cured binder constitutes about 5 wt. % to about 15 wt. % of the finished insulation product, although it can be as little as 1 wt. % or less and as high as 20 wt. % or more, depending upon the type of glass fiber product. Optimally, the amount of binder for most glass fiber insulation products will be the amount necessary to lock each fiber into the mass by bonding the fibers where they cross or overlap. For this reason, it is desired to have binder compositions with good flow characteristics, so that the binder solution can be applied to the fiber at a low volume that will flow to the fiber intersections.

The glass fiber products of the present invention thus are to be distinguished from products in which the “binder” constitutes a substantially continuous phase merely reinforced with glass fibers. In the present invention, the glass fibers are the major constituent of the product and the binder is only provided in an amount sufficient to bond together the loosely associated mat or blanket of fibers, such as primarily at the intersection thereof.

The ultimate binder composition for application to the glass fibers may comprise a variety of liquid forms, including solutions, miscible liquids, or dispersions and the like and combinations of such liquid forms depending upon the optional ingredients blended into the binder composition. Where the term solution, or any of the variations thereof is used herein it is intended to include any relatively stable liquid phase that is infinitely water dilutable.

Generally, the binder formulation should be relatively stable for periods of time long enough to permit mixing and application at temperatures ordinarily encountered in glass fiber product manufacturing plants, especially fiberglass insulation manufacturing facilities, typically greater than 4 hours. Alternatively, the binder components may be combined, diluted and sprayed onto the glass fibers immediately if the glass fiber manufacturer has an in-line binder mixing system. Also, the binder formulation should be infinitely dilutable in order to permit variations in concentrations for different end products. The cured binder must provide a strong bond with sufficient elasticity and thickness recovery to permit reasonable shipping and in-service deformation of the glass fiber product. It also should be moisture resistant so that it does not swell under humid conditions. Additionally, it should be odor free and non-corrosive to metals with which it comes in contact. The binder should be capable of withstanding temperatures approaching the temperatures that the glass fibers can withstand, particularly for pipe insulation where the pipeline is used for hot fluids.

To prepare a binder formulation, it may also be advantageous to add a silane coupling agent (organo silicon oil) to the polyester resin composition in an amount of at least about 0.05 wt. % based on the weight of binder solids. Suitable silane coupling agents (organo silicon oils and fluids) are marketed by the Dow-Corning Corporation, Petrarch Systems, and by the General Electric Company. Their formulation and manufacture are well known such that detailed description thereof need not be given. When employed in the binder composition of this invention, the silane coupling agents typically are present in an amount within the range of about 0.1 to about 2.0 percent by weight based upon the binder solids and preferably in an amount within the range of 0.1 to 0.5 percent by weight.

Representative silane coupling agents are the organo silicon oils marketed by Dow-Corning Corporation; A0700, A0750 and A0800 marketed by Petrarch Systems and A1100 (an amino propyl, trimethoxy silane) or A1160 marketed by Dow Chemical Corporation.

The binder may be prepared by combining the aqueous epoxide composition and the silane coupling agent in a relatively easy mixing procedure carried out at ambient temperatures. The binder can be used immediately and may be further diluted with water to a concentration suitable for the desired method of application, such as by spraying onto the glass fibers.

The aqueous epoxide binder composition may also contain, as an optional component, a catalyst which is preferably present in an amount of 20 wt. % or less, more preferably less than 10 wt. %, even more preferably less than 5 wt. %, and most preferably no more than 2 wt. %, based on the combined weight of the binder solids. Preferably, the catalyst is a tertiary amine such as benzyl dimethylamine, an imidazole, or, an imidazoline, a urea, or a boron halide complex.

In formulating the binder it may also be advantageous to acidify the composition to facilitate a more complete cure of the binder mixture by the addition of an acid, such as lactic acid or another organic or inorganic acid.

Other conventional binder additives compatible with the epoxide composition and silane coupling agent also may be added to the binder destined for application to the glass fibers. Such additives include such conventional treatment components as, for example, emulsifiers, pigments such as carbon black, fillers, anti-migration aids, dedusting agents, curing agents including latent acid catalysts, coalescents, wetting agents, biocides, plasticizers, anti-foaming agents, colorants, waxes, lignin, and anti-oxidants.

The particular method used for forming glass fibers for use in the present invention is relatively unimportant. Processes for making glass fiber products, especially glass fiber insulation products, using an epoxide binder compositon of the present invention are typically carried out according to one of a number of methods wherein a molten mineral material flowing from a melting furnace is divided into streams and attenuated into fibers. The attenuation can be done by centrifuging and/or fluid jets to form discontinuous fibers of relatively small dimensions, which typically are collected by random depositing on a moving foraminous (porous) conveyor belt. The fibers are collected in a felted haphazard manner to form a mat or blanket. The volume of fiber in the mat or blanket will be determined by the speed of fiber formation and the speed of the belt.

Continuous glass fibers also may be employed in the form of mats or blankets fabricated by swirling the endless filaments or strands of continuous fibers, or they may be chopped or cut to shorter lengths for mat or blanket formation. Use can also be made of ultra-fine fibers formed by the attenuation of glass rods. Also, such fibers may be treated with a size, anchoring agent or other modifying agent before use.

Glass fiber products, including glass fiber insulation products, may also contain fibers that are not in themselves heat-resistant such as, for example, certain polyester fibers, rayon fibers, nylon fibers, and superabsorbent fibers, in so far as they do not materially adversely affect the performance of the product.

In order to produce most glass fiber products, including glass fiber insulation products, the fibers must be bonded together in an integral structure. To achieve this binding, the curable epoxide binder material of the present invention is applied to the glass fiber mat or blanket. The layer of fiber with binder is then mildly compressed and shaped into the form and dimensions of the desired product. The glass fiber product, especially the glass fiber insulation product, then is passed through a curing oven where the binder is cured fixing the size and shape of the finished product.

The aqueous epoxide binder composition may be applied to the glass fibers by conventional techniques such as, for example, air or airless spraying, padding, saturating, roll coating, curtain coating, beater deposition, and coagulation. For example, the aqueous epoxide binder can be applied to the glass fibers by flooding the collected mat or blanket of glass fibers and draining off the excess, by applying the binder composition onto the glass fibers during mat or blanket formation, by spraying the glass fiber mat or the like. As noted above, the layer of fiber with binder is then mildly compressed and shaped into the form and dimensions of the desired glass fiber product, especially glass fiber insulation product, such as pipe, batt or board and passed through a curing oven where the binder is cured, thus fixing the size and shape of the finished product by bonding the mass of fibers one to another and forming an integral composite structure.

The aqueous epoxide binder, after it is applied to the glass fiber, is heated to effect drying and curing. The duration and temperature of heating will affect the rate of drying, processability and handleability, degree of curing and property development of the treated substrate. The curing temperatures are within the range from 110 to 300° C., preferably within the range from 125 to 250° C. and the curing time will usually be somewhere between 3 seconds to about 15 minutes, for example 6 minutes at 200° C.

On heating, the water present in the binder composition evaporates, and the binder composition undergoes curing. These processes can take place in succession or simultaneously. Curing in the present context is to be understood as meaning the chemical alteration of the composition, for example crosslinking through formation to covalent bonds between the various constituents of the composition, formation of ionic interactions and clusters, formation of hydrogen bonds. Furthermore, the curing can be accompanied by physical changes in the binder, for example phase transitions or phase inversion.

As noted, the drying and curing functions may be accomplished in two or more distinct steps, if desired. For example, the composition may be first heated at a temperature and for a time sufficient to substantially dry but not to substantially cure the binder composition and then heated for a second time at a higher temperature and/or for a longer period of time to effect curing (crosslinking). Such a procedure, referred to as “B-staging”, may be used to provide a binder-treated glass fiber product, such as a glass fiber insulation product, for example, in roll form, which may at a later stage be cured, with or without forming or molding into a particular configuration, concurrent with the curing process. This processing makes it possible, for example, to use the compositions of this invention for producing binder-impregnated semifabricates that can be molded and cured elsewhere.

The glass fiber component will represent the principal material of the glass fiber product, including glass fiber insulation products. Usually 99-60 percent by weight of the product will be composed of the glass fibers, while the amount of cured epoxide binder (solids) usually will be in reverse proportion ranging from 1-40 percent, depending upon the density and character of the product. Glass fiber insulation products having a density less than one pound per cubic foot may be formed with binders present in the lower range of concentrations while molded or compressed products having a density as high as 30-40 pounds per cubic foot can be fabricated of systems embodying the binder composition in the higher proportion of the described range.

Glass fiber products can be formed as a relatively thin product of about 0.25 to 1.5 inch or it can be a thick mat or blanket of 12 to 14 inches or more. The time and temperature for cure will depend in part on the amount of binder in the final structure and the thickness and density of the structure that is formed. For a structure having a thickness ranging from 0.25 to 1.5 inch, a cure time ranging from 1-5 minutes will be sufficient at a cure temperature within the range of 175°-300° C.

The glass fiber products, and particularly the glass fiber insulation products may be used for applications such as, for example, insulation batts or rolls, as reinforcing mat for roofing or flooring applications, as roving, as microglass-based substrate for preparing laminated printed circuit boards or battery separators, as filter stock, as tape stock, and as reinforcement scrim in cementitious and non-cementitious coatings for masonry.

The following examples are intended to illustrate the invention further. It is to be understood that these examples are for purposes of illustration only and are not intended to limit the scope of the invention.

### EXAMPLE 1

A polyamidoamine polymer (having a repeating unit molecular weight of about 213) can be prepared by reacting diethylenetriamine and adipic acid at a mol ratio of amine to acid of about 0.97 mol amine to 1.0 mol acid. The acid is added to the amine causing the reaction mixture to exotherm to about 145° C. Thereafter, the reaction mixture is heated to about 165° C. and water is distilled as the condensation reaction proceeds to yield a product having about 45% solids at a viscosity of about 340 to 470 cP. This polymer exhibits a weight average molecular weight of about 17,000 to 20,000.

### EXAMPLE 2

Another polyamidoamine polymer (having a repeating unit molecular weight of about 213) can be prepared as follows: Diethylenetriamine (412.7 g) is added to a 2.5 liter reaction vessel equipped with a mechanical stirrer, thermometer, and distillation condenser. Solid adipic acid (438.4 g) is then added over a 15 minute period while heating at 70° C. The mol ratio of diethylenetriamine (polyalkylene polyamine) to adipic acid (diacid) is 1.3:1. This is the same as the mole ratio of primary amine moieties (groups) to carboxylic acid moieties (groups). Upon completing the addition of adipic acid, the temperature of the reaction mixture is increased to 150° C. over a 105 minute period, at which time water begins to distill from the reaction vessel. The temperature of the reaction mixture is then increased to 165° C. and held at that temperature for the duration of the reaction. After 5 elapsed hours a slow, steady stream of anhydrous nitrogen is bubbled through the reaction mixture. After 7 elapsed hours the flow of nitrogen gas is halted and the reaction vessel is vacuum distilled at ca. 20 in. Hg for one hour. After an elapsed time of 8 hours (i.e., at the end of one hour of vacuum distillation), the distillation condenser is converted to a reflux condenser. Water (1553.9 g) is slowly added via the reflux condenser to the reaction mixture over a one hour period, with the temperature of the reaction mixture dropping from 165° C. to about 100° C. during that time. The resulting aqueous diethylenetriamine-adipic acid oligomer solution is cooled to 25° C. and should have a Gardner-Holdt viscosity of DEE, a solids content of about 48 wt. % and a molecular weight of about 740.

### EXAMPLE 3

A binder was prepared using the polyamidoamine polymer epoxide crosslinking agent of Example 2 as follows: 154.4 grams of the polyamidoamine polymer of Example 2 was mixed with 204.6 of the diglycidal ether of bisphenol A (Epoxy EPI REZ 3510-W-60 available from the Shell Chemical Company, Resolution Performance Products, Houston, Tex.) o prepare a binder containing 20 weight percent solids. The ingredients were added to a ½ gallon jar and mixed well.

### EXAMPLE 4

Wet tensile strengths of hand sheets prepared using the curable aqueous binder composition of Example 3 were examined. Hand sheets were prepared by sprinkling the binder onto a glass mat, formed from ½ inch PPG M-8035 chopped glass fibers dispersed in water containing a polyacrylamide, vacuuming the excess binder off the glass fibers and then curing the sheet in an oven at 200 to 240° C. for 1 to 5 minutes.

Hot/wet tensile strength of mats prepared using the binder of Example 3 were then measured by soaking the handsheets in 185° F. (85° C.) water for 10 minutes. Samples of the hand sheets (3 inches by 5 inches) were then subjected to breaking a tensile tester (QC-1000 Materials Tester by the Thwing Ibert Instrument Co.) while they were still hot and wet. The hand sheet made from the binder of Example 3 exhibited a hot/wet tensile strength of 41 pounds. A typical PF resin binder exhibited a hot/wet tensile of about 35 pounds.

The present invention has been described with reference to specific embodiments. However, this application is intended to cover those changes and substitutions that may be made by those skilled in the art without departing from the spirit and the scope of the invention.

We claim:

1. An aqueous binder composition for making glass fiber insulation products comprising an aqueous solution of a substantially infinitely water-dilutable or dispersible mixture of an epoxide and an epoxide crosslinking agent.

2. The aqueous binder composition of claim 1 wherein the epoxide is an infinitely water-dilutable or dispersible diglycidyl ether of a polyol.

3. The aqueous binder composition of claim 2 wherein the polyol for making the epoxide is selected from the group consisting of bisphenol A, bisphenol F, glycerol and tetrakis (hydroxyphenyl) ethane.

4. The aqueous binder composition of claim 1 wherein the epoxide crosslinking agent is a polycarboxylic acid, polycarboxylic acid anhydride, maleated rosin, acid terminated polyester, polyfunctional amine, polypeptide, dicyandiamide derivative and imidazole.

5. The aqueous binder composition of claim 4 wherein the epoxide crosslinking agent is a polyamidoamine polymer.

6. A method for binding together a loosely associated mat of glass fibers comprising (1) contacting said glass fibers with an aqueous binder composition comprising an aqueous solution of a substantially infinitely water-dilutable or dispersible mixture of an epoxide and an epoxide crosslinking agent, and (2) heating said aqueous binder composition at an elevated temperature sufficient to effect cure.

7. The method for binding of claim 6 wherein the epoxide is an infinitely water-dilutable or dispersible diglycidyl ether of a polyol.

8. The method for binding of claim 7 wherein the polyol for making the epoxide is selected from the group consisting of bisphenol A, bisphenol F, glycerol and tetrakis (hydroxyphenyl) ethane.

9. The method for binding of claim 6 wherein the epoxide crosslinking agent is a polycarboxylic acid, polycarboxylic acid anhydride, maleated rosin, acid terminated polyester, polyfunctional amine, polypeptide, dicyandiamide derivative and imidazole.

10. The method for binding of claim 9 wherein the epoxide crosslinking agent is a polyamidoamine polymer.

11. An glass fiber product comprising a crosslinked (cured) composition obtained by curing an aqueous binder composition comprising an aqueous solution of a substantially infinitely water-dilutable or dispersible mixture of an epoxide and an epoxide crosslinking agent applied to a mat of nonwoven glass fibers.

12. The glass fiber product of claim 11 wherein the epoxide is an infinitely water-dilutable or dispersible diglycidyl ether of a polyol.

13. The glass fiber product of claim 12 wherein the polyol for making the epoxide is selected from the group consisting of bisphenol A, bisphenol F, glycerol and tetrakis (hydroxyphenyl) ethane.

14. The glass fiber product of claim 11 wherein the epoxide crosslinking agent is a polycarboxylic acid, polycarboxylic acid anhydride, maleated rosin, acid terminated polyester, polyfunctional amine, polypeptide, dicyandiamide derivative and imidazole.

15. The glass fiber product of claim 14 wherein the epoxide crosslinking agent is a polyamidoamine polymer.
